(19) United States
(12) Patent Application Publication
(10) Pub. No.: US 2005/0124493 A1
(43) Pub. Date: Jun. 9, 2005

(54) Herbicidal composition

(76) Inventor: Matthias Brandl, Madrid (ES)

Correspondence Address: SYNGENTA CROP PROTECTION , INC.;PATENT AND TRADEMARK DEPARTMENT, 410 SWING ROAD, GREENSBORO, NC, 27409, US

(21) Appl. No.: 10/502,629

(22) PCT Filed: Feb. 12, 2003
(86) PCT No.: PCT/EP03/01388

(30) Foreign Application Priority Data
Feb. 13, 2002 (CH) 23902

(51) Int. Cl. A01N 25/32; A01N 43/56; A01N 43/647; A01N 43/713

(52) U.S. Cl. 504/105; 504/139

(57) ABSTRACT

A selectively herbicidal composition for controlling grasses and weeds in crops of useful plats, comprising a) a herbicidally effective mixture of MCPA, bromoxynil and a compound of formula (I) wherein the substituents are as defined in claim 1 and b) an amount, effective for herbicide antagonism, of a compound of formula (II) wherein the substituents are as defined in claim 1.

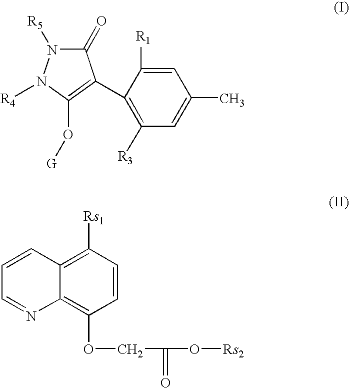

The present invention relates to new selectively herbicidal compositions for controlling grasses and weeds in crops of useful plants, especially in crops of cereals, maize and sorghum, which compositions comprise a herbicide and a safener (counter-agent, antidote) and protect the useful plants but not the weeds against the phytotoxic action of the herbicide, and to the use of such a composition in controlling weeds in crops of useful plants.

The use of herbicides can result in considerable damage also being caused to cultivated plants, for example in dependence upon the concentration of the herbicide and the mode of its application, the cultivated plant, the nature of the soil and the climatic conditions, such as period of exposure to light, temperature and amounts of precipitation. In order to counter those and similar problems, various substances have already been proposed as safeners that are capable of antagonising the damaging action of the herbicide on the cultivated plant, that is to say of protecting the cultivated plant against that action, while the herbicidal action on the weeds to be controlled is virtually unimpaired. It has been found that the proposed safeners often have a very specific action both in respect of the cultivated plants and in respect of the herbicide and in some cases also in dependence upon the mode of application. This means that a specific safener is often suitable only for a specific cultivated plant and a particular class of herbicide or a specific herbicide. For example, compounds known from EP 94 349, WO 96/21652 and WO 99/47525 protect the cultivated plants against the phytotoxic action of herbicides such as, for example, the 3-hydroxy-4-aryl-5-oxo-pyrazoline derivatives known from WO 96/21652 and WO 99/47525.

It has now been found that the compounds of formula II 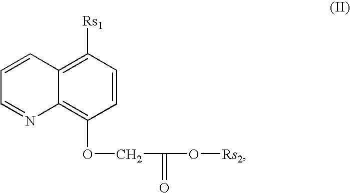
wherein
Rs₁ is hydrogen or chlorine and Rs₂ is hydrogen, C₁-C₈alkyl, or Cl-C₈alkyl substituted by C₁-C₆alkoxy or by C₃-C₆alkenyloxy,
are suitable for protecting cultivated plants against the phytotoxic action of a mixture of 3-hydroxy-4-aryl-5-oxo-pyrazoline herbicides known from WO 01/17353, MCPA and bromoxynil. MCPA and bromoxynil are described in The Pesticide Manual, Twelfth Edition, 2000, Entry Nos. 93, and 485 and 486.

There is accordingly proposed, in accordance with the invention, a selectively herbicidal composition that, in addition to comprising customary inert formulation adjuvants such as carriers, solvents and wetting agents, comprises as active ingredient a mixture of
a) a herbicidally effective amount of a mixture of MCPA, bromoxynil and a herbicide of formula I 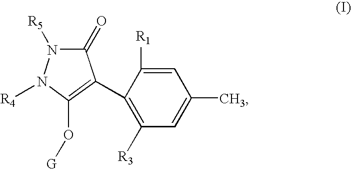
   wherein R₁ and R₃ are each independently of the other ethyl, haloethyl, ethynyl, C₁- or C₂-alkoxy, C₁- or C₂-haloalkoxy, C₁- or C₂-alkylcarbonyl or C₁- or C₂-hydroxyalkyl;
R₄ and R₅ together are a group Z₂-CR₁₄(R₁₅)—CR₁₆(R₁₇)—O—CR₁₈(R₁₉)-CR₂₀(R₂₁)-(Z₂);
R₁₄, R₁₅, R₁₆, R₁₇, R₁₈, R₁₉, R₂₀ and R₂₁, are each independently of the others hydrogen, halogen, C₁-C₄alkyl or C₁-C₄haloalkyl, it being possible for an alkylene ring to be either fused or spiro-linked to the carbon atoms of the group Z₂, which alkylene ring contains, together with the carbon atoms of the group Z₂ to which it is bonded, from 2 to 6 carbon atoms and may be interrupted by oxygen, or that alkylene ring bridges at least one ring atom of the group Z₂;
G is hydrogen, —C(X₁)—R₃₀, —C(X₂)—X₃—R₃₁, —C(X₄)—NR₃₂(R₃₃), —S(O)₂—R₃₄, —P(X₅)R₃₅R₃₆, —CH₂—X₆—R₃₇ or an alkali metal cation, alkaline earth metal cation, sulfonium cation or ammonium cation;
X₁, X₂, X₃, X₄, X₅ and X₆ are each independently of the others oxygen or sulfur;
R₃₀, R₃₁, R₃₂, R₃₃, R₃₄, R₃₅, R₃₆ and R₃₇ are each independently of the others hydrogen,
C₁-C₁₀alkyl, C₁-C₁₀haloalkyl, C₁-C₁₀cyanoalkyl, C₁-C₁₀nitroalkyl, C₁-C₁₀aminoalkyl, C₂-C₅-alkenyl, C₂-C₅haloalkenyl, C₃-C₈cycloalkyl, C₁-C₅alkylamino-C₁-C₅alkyl, di(C₁-C₅alkyl)amino-C₁-C₅alkyl, C₃-C₇cycloalkyl-C₁-C₅alkyl, C₁-C₅alkoxy-C₁-C₅alkyl, C₃-C₅alkenyloxy-C₁-C₅alkyl, C₃-C₅alkynyloxy-C₁-C₅alkyl, C₁-C₅alkylthio-C₁-C₅alkyl, C₁-C₅alkylsulfoxyl-C₁-C₅alkyl, C₁-C₅-alkylsulfonyl-C₁-C₅alkyl, C₂-C₈alkylideneaminooxy-C₁-C₅alkyl, C₁-C₅alkylcarbonyl-C₁-C₅alkyl, C₁-C₅alkoxycarbonyl-C₁-C₅alkyl, C₁-C₅alkylaminocarbonyl-C₁-C₅alkyl, di(C₁-C₅alkyl)amino-carbonyl-C₁-C₅alkyl, C₁-C₅alkylcarbonylamino-C₁-C₅alkyl, C₁-C₅alkylcarbonyl(C₁-C₅alkyl)-amino-C₁-C₅alkyl, tri(C₁- or C₂-alkyl)silyl-C₁-C₅alkyl, phenyl, heteroaryl, phenyl-C₁-C₅alkyl, heteroaryl-C₁-C₅alkyl, phenoxy-C₁-C₅alkyl or heteroaryloxy-C₁-C₅alkyl, it being possible for the afore-mentioned aromatic rings to be substituted by halogen, nitro, cyano, amino, di(C₁-C₄alkyl)amino, hydroxy, methoxy, ethoxy, methylthio, ethylthio, formyl, acetyl, propionyl, carboxyl, C₁-C₅alkoxycarbonyl or by C₁- or C₂-haloalkyl; R₃₄, R₃₅ and R₃₆ are, in addition, C₁-C₁₀alkoxy, C₁-C₁₀haloalkoxy, C₁-C₅alkylamino, di(C₁-C₅-alkyl)amino, benzyloxy or phenoxy, it being possible for the aromatic rings of the last two substituents to be substituted by halogen, nitro, cyano, amino, dimethylamino, hydroxy, methoxy, ethoxy, methylthio, ethylthio, formyl, acetyl, propionyl, carboxyl, C₁-C₅alkoxy-carbonyl or by C₁- or C₂-haloalkyl; and
R₃₇ is, in addition, C₁-C₁₀alkylcarbonyl,
or a salt or diastereoisomer of a compound of formula I, and
b) an amount, effective for herbicide antagonism, of a safener of formula II 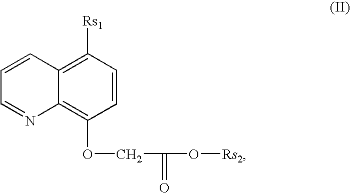
   wherein Rs₁ is hydrogen or chlorine and Rs₂ is hydrogen, C₁-C₈alkyl, or C₁-C₈alkyl substituted by C₁-C₆alkoxy or by C₃-C₆alkenyloxy.

Preferred selectively herbicidal compositions comprise, as compound of formula II, a compound of that formula wherein Rs₁ is chlorine and Rs₂ is C₁-C₈alkyl.

Herbicides of formula I to which preference is given for the composition according to the invention are those wherein R₁ and R₃ are each independently of the other ethyl, haloethyl, ethynyl, C₁- or C₂-alkoxy or C₁- or C₂-haloalkoxy.

Further preferred compositions comprise, as compound of formula I, a compound of that formula wherein R₄ and R₅ together form a group Z₂-CR₁₄(R₁₅)—CR₁₆(R₁₇)—O—CR₁₈(R₁₉)—CR₂₀(R₂,)—
wherein R₁₄, R₁₅, R₁₆, R₁₇, R₁₈, R₁₉, R₂₀ and R₂₁ are hydrogen.

Preference is furthermore given to those compositions that comprise, as compound of formula I, a compound of that formula wherein G is hydrogen, —C(X₁)—R₃₀, —C(X₂)—X₃—R₃₁, —C(X₄)—NR₃₂(R₃₃), —S(O)₂—R₃₄, —P(X₅)R₃₅R₃₆, —CH₂—X₅—R₃₇ or an alkali metal cation, alkaline earth metal cation, sulfonium cation or ammonium cation; X₁, X₂, X₃, X₄, X₅ and X₆ are each independently of the others oxygen or sulfur; R₃₀, R₃₁, R₃₂, R₃₃, R₃₄, R₃₅, R₃₆ and R₃₇ are each independently of the others hydrogen, C₁-C₈alkyl, C₁-C₈haloalkyl, C₁-C₈cyanoalkyl, C₁-C₈-nitroalkyl, C₁-C₈aminoalkyl, C₂-C₅alkenyl, C₂-C₅haloalkenyl, C₃-C₈cycloalkyl, C₁-C₅alkylamino-C₁-C₂alkyl, di(C₁-C₅alkyl)amino-C₁-C₂alkyl, C₃-C₇cycloalkyl-C₁-C₂alkyl, C₁-C₄alkoxy-C₁-C₄-alkyl, C₂-C₄alkenyloxy-C₁-C₄alkyl, C₃-C₄alkynyloxy-C₁-C₄alkyl, C₁-C₄alkylthio-C₁-C₄alkyl, C₁-C₂alkylsulfoxyl-C₁-C₂alkyl, C₁-C₂alkylsulfonyl-C₁-C₂alkyl, C₂-C₈alkylideneaminooxy-C₁-C₂-alkyl, C₁-C₅alkylcarbonyl-C₁-C₂alkyl, C₁-C₆alkoxycarbonyl-C₁-C₂alkyl, C₁-C₅alkylamino-carbonyl-C₁-C₂alkyl, di(C₁-C₄alkyl)aminocarbonyl-C₁-C₂alkyl, C₁-C₅alkylcarbonylamino-C₁-C₂-alkyl, C₁-C₂alkylcarbonyl(C₁-C₃alkyl)amino-C₁-C₂alkyl, tri(C₁- or C₂-alkyl)silyl-C₁-C₃alkyl, phenyl, heteroaryl, phenyl-C₁-C₂alkyl, heteroaryl-C₁-C₂alkyl, phenoxy-C₁-C₂alkyl or heteroaryloxy-C₁-C₂alkyl; R₃₄, R₃₅ and R₃₆ are, in addition, C₁-C₆alkoxy, C₁-C₆haloalkoxy, C₁-C₃alkylamino, di(C₁-C₃alkyl)amino, benzyloxy or phenoxy, it being possible for the aromatic rings of the last two substituents to be substituted by halogen, nitro, cyano, amino, dimethylamino, hydroxy, methoxy, ethoxy, methylthio, ethylthio, formyl, acetyl, propionyl, carboxyl, C₁-C₅alkoxycarbonyl or by C₁- or C₂-haloalkyl; and
R₃₇ is, in addition, C₁-C₈alkylcarbonyl.

Of those compositions, special preference is given to those comprising, as compound of formula I, a compound of that formula wherein G is hydrogen, —C(X₁)—R₃₀, —C(X₂)—X₃—R₃₁, —C(X₄)—NR₃₂(R₃₃), —S(O)₂—R₃₄, —P(X₅)R₃₅R₃₆, —CH₂—X₆—R₃₇ or an alkali metal cation, alkaline earth metal cation, sulfonium cation or ammonium cation; X₁, X₂, X₃, X₄, X₅ and X₆ are each independently of the others oxygen or sulfur; R₃₀, R₃₁, R₃₂, R₃₃, R₃₄, R₃₅, R₃₆ and R₃₇ are each independently of the others hydrogen, C₁-C₈alkyl, C₁-C₈haloalkyl, C₂-C₅alkenyl, C₂-C₅halo-alkenyl, C₃-C₈cycloalkyl, C₃-C₇cycloalkyl-C₁-C₂alkyl, C₁-C₄alkoxy-C₁-C₄alkyl, phenyl, heteroaryl, phenyl-C₁-C₂alkyl, heteroaryl-C₁-C₂alkyl, phenoxy-C₁-C₂alkyl or heteroaryloxy-C₁-C₂-alkyl; R₃₄, R₃₅ and R₃₆ are, in addition, C₁-C₆alkoxy, C₁-C₃alkylamino, di(C₁-C₃alkyl)amino;
and R₃₇ is, in addition, C₁-C₈alkylcarbonyl.

Of very special value are those compositions that comprise a) a mixture of MCPA, bromoxynil and a herbicide of formula I wherein G is hydrogen or —C(X₂)—X₃—R₃₁, wherein X₂ and X₃ are oxygen, and R₃₁ is tert-butyl, and b) a safener of formula II wherein Rs₁ is chlorine and Rs₂ is 1-methylcyclohexyl.

The invention relates also to a method for the selective control of weeds in crops of useful plants, which method comprises treating the useful plants, their seeds or cuttings or the crop area thereof, simultaneously or separately, with a) a herbicidally effective amount of a mixture of MCPA, bromoxynil and a compound of formula I, b) an amount, effective for herbicide antagonism, of a safener of formula II and, optionally, c) an additive comprising an oil of vegetable origin, or an alkylated derivative thereof, or a mineral oil, or a mixture thereof.

Cultivated plants that may be protected against the harmful effect of the above-mentioned herbicides by means of the safeners of formula II are especially cereals, maize and sorghum. Crops are to be understood as including those that have been made tolerant to herbicides or classes of herbicides by means of conventional breeding or genetic engineering methods, for example IMI Maize, Poast Protected Maize (sethoxydim tolerance), Liberty Link Maize, B.t./Liberty Link Maize, IMI/Liberty Link Maize, IMI/Liberty Link /B.t. Maize, Roundup Ready Maize and Roundup Ready/B.t. Maize.

The weeds to be controlled may be either monocotyledonous or dicotyledonous weeds such as, for example, Stellaria, Nasturtium, Agrostis, Digitaria, Avena, Setaria, Sinapis, Lolium, Solanum, Echinochloa, Scirpus, Monochoria, Sagittaria, Bromus, Alopecurus, Sorghum halepense, Rottboellia, Cyperus, Abutilon, Sida, Xanthium, Amaranthus, Chenopodium, Ipomoea, Chrysanthemum, Galium, Viola and Veronica.

Crop areas are areas of land on which the cultivated plants are already growing or in which the seeds of those cultivated plants have been sown, and also land on which it is intended to grow those cultivated plants.

A safener of formula II may, depending on the intended purpose, be used to pre-treat the seed material of the cultivated plant (dressing the seed or the cuttings) or may be incorporated into the soil before or after sowing. It may, however, also be applied, alone or together with the herbicide and, optionally, the oil additive, after the emergence of the plants. The treatment of the plants or seed with the safener can therefore, in principle, be effected independently of the time at which the herbicide is applied. The treatment of the plants can, however, also be carried out by applying the herbicide and safener simultaneously (for example in the form of a tank mixture). The rate of application of the safener in relation to the herbicide depends largely on the method of application. In the case of field treatment, which is effected either using a tank mixture with a combination of the safener and the herbicide or by the separate application of the safener and the herbicide, the ratio of herbicide (or herbicide mixture) to safener is generally from 1:100 to 100:1, preferably from 1:10 to 10:1, and especially from 1:5 to 5:1.

In the case of field treatment, from 0.001 to 5.0 kg of safener/ha, preferably from 0.001 to 0.5 kg of safener/ha, are generally applied. The rate of application of herbicide (or herbicide mixture) is generally from 0.001 to 2 kg/ha, but preferably from 0.005 to 0.5 kg/ha.

The compositions according to the invention may, in addition, comprise additives comprising an oil of vegetable origin, or an alkylated derivative thereof, or a mineral oil, or a mixture thereof. Preferably, such additives are added to the spray tank (tank mixture); advantageously in an amount of from 0.01 to 2%, based on the spray mixture. The additive can, for example, be added to the spray tank in the desired concentration after the spray mixture has been prepared. Preference is given to additives comprising oils of vegetable origin. Special preference is given to additives comprising, for example, the following components (A) from 20 to 90% by weight of alkyl esters of higher (C₄-C₂₂) fatty acids, (B) from 4 to 40% by weight of anionic or non-ionic surfactants, (C) from 2 to 20% by weight of higher (C₁₀-C₂₀) fatty acids, and (D) up to 140% by weight, based on the total amount of components (A) to (C), of hydrocarbons.

Especially suitable additives comprise, as component (A), alkyl esters of higher (C₈-C₂₂) fatty acids, especially the C₁-C₄alkyl ester derivatives of C₁₂-C₁₈ fatty acids, for example the methyl esters of lauric acid, palmitic acid and oleic acid. Those esters are known as methyl laurate (CAS-111-82-0), methyl palmitate (CAS-112-39-0) and methyl oleate (CAS-112-62-9). The application and action of the additives can be improved by combining them with surface-active substances such as, for example, anionic surfactants (B). Examples of suitable anionic surfactants are surfactants of the dodecylbenzylsulfonate type, especially the calcium salts thereof. The concentration of the surface-active substances, based on the total additive, is generally from 1 to 30% by weight. Preferred higher fatty acids (C) contain from 12 to 18 carbon atoms.

The presence of an organic solvent (D) can, furthermore, bring about a further increase in action. Preferred solvents (D) are, for example, aromatic solvents such as Solvesso® (ESSO) or Aromatic Solvent® (Exxon Corporation) types. The concentration of those solvents can be from 10 to 80%, by weight, of the total weight. Such oil additives are described, for example, in U.S. Pat. No.4,834,908. They are especially preferred for the composition according to the invention. An oil additive to which very special preference is given is known under the name MERGE®. In the compositions according to the invention there may accordingly be used, as preferred additive, an additive comprising (A) C₁-C₄alkyl esters of C₁₂-C₁₈ fatty acids, (B) anionic surfactants of the dodecylbenzylsulfonate type, (C) C₁₂-C₁₈ fatty acids, and (D) aromatic hydrocarbons.

The compositions according to the invention are suitable for all methods of application that are customary in agriculture, for example pre-emergence application, post-emergence application and seed dressing. In the case of seed dressing, from 0.001 to 10 g of safener/kg of seed, preferably from 0.05 to 2 g of safener/kg of seed, are generally applied. When the safener is applied in liquid form shortly before sowing, with swelling of the seed, it is advantageous to use safener solutions that comprise the active ingredient in a concentration of from 1 to 10 000 ppm, preferably from 100 to 1000 ppm.

For application, the safeners of formula II or combinations of those safeners with MCPA, bromoxynil and the herbicides of formula I and, optionally, the additives are advantageously processed, together with the adjuvants conventionally employed in formulation technology, into formulations, for example into emulsifiable concentrates, coatable pastes, directly sprayable or dilutable solutions, dilute emulsions, wettable powders, soluble powders, dusts, granules or microcapsules. Such formulations are described, for example, in WO 97/34485, on pages 9 to 13. The formulations are prepared in known manner, for example by intimately mixing and/or grinding the active ingredients with liquid or solid formulation adjuvants, for example solvents or solid carriers. Furthermore, surface-active compounds (surfactants) may additionally be used in the preparation of the formulations. Solvents and solid carriers that are suitable for that purpose are mentioned, for example, in WO 97/34485 on page 6.

Suitable surface-active compounds are, depending on the nature of the active ingredient being formulated, non-ionic, cationic and/or anionic surfactants and mixtures of surfactants having good emulsifying, dispersing and wetting properties. Examples of suitable anionic, non-ionic and cationic surfactants are listed, for example, in WO 97/34485 on pages 7 and 8.

Furthermore, the surfactants customarily employed in formulation technology, which are described, inter alia, in “Mc Cutcheon's Detergents and Emulsifiers Annual” MC Publishing Corp., Ridgewood N.J., 1981, Stache, H., “Tensid-Taschenbuch”, Carl Hanser Verlag, Munich/Vienna, 1981 and M. and J. Ash, “Encyclopedia of Surfactants”, Vol I-III, Chemical Publishing Co., New York, 1980-81, are also suitable for preparation of the herbicidal compositions according to the invention.

The herbicidal formulations generally comprise from 0.1 to 99% by weight, especially from 0.1 to 95% by weight, of active ingredient mixture comprising MCPA, bromoxynil and the compound of formula I together with the compounds of formula II, from 0 to 2% by weight of the oil additive, from 1 to 99.9% by weight of a solid or liquid formulation adjuvant and from 0 to 25% by weight, especially from 0.1 to 25% by weight, of a surfactant. Whereas commercial products will preferably be formulated as concentrates, the end user will normally employ dilute formulations.

The compositions may also comprise further additives such as stabilisers, for example vegetable oils or epoxidised vegetable oils (epoxidised coconut oil, rapeseed oil or soybean oil), antifoams, for example silicone oil, preservatives, viscosity regulators, binders and tackifiers, as well as fertilisers or other active ingredients. There are various suitable methods and techniques for using safeners of formula II or compositions comprising them for protecting cultivated plants against harmful effects of the mixture of MCPA, bromoxynil and the herbicide of formula I; the following are examples:

i) Seed Dressing

a) Dressing the seeds with a wettable powder formulation of a compound of formula II by shaking in a vessel until the formulation is uniformly distributed over the seed surface (dry dressing). Approximately from 1 to 500 g of compound of formula II (from 4 g to 2 kg of wettable powder) are used per 100 kg of seed.

b) Dressing the seeds with an emulsifiable concentrate of the compound of formula II according to method a) (wet dressing).

c) Dressing by immersing the seed in a liquid formulation comprising from 100 to 1000 ppm of compound of formula II for from 1 to 72 hours and, if desired, subsequently drying the seeds (immersion dressing).

Dressing the seed or treating the germinated seedlings are naturally the preferred methods of application because the treatment with the active ingredient is directed wholly at the target crop. Generally from 1 to 1000 g of antidote, preferably from 5 to 250 g of antidote, are used per 100 kg of seed, although, depending on the method employed, which also allows the addition of other active ingredients or micronutrients, amounts above or below the specified concentration limits may be employed (repeat dressing).

ii) Application in the Form of a Tank Mixture

A liquid formulation of a mixture of antidote and herbicide (ratio of the one to the other from 10:1 to 1:100) is used, the rate of application of herbicide being from 0.005 to 5.0 kg per hectare. Such tank mixtures are applied before or after sowing.

iii) Application to the Seed Furrow

The compound of formula II is introduced into the open, sown seed furrow in the form of an emulsifiable concentrate, a wettable powder or granules. After the seed furrow has been covered, the herbicide is applied pre-emergence in the normal manner.

iv) Controlled Release of the Active Ingredient

The compound of formula II is applied in solution to granulated mineral carriers or polymerised granules (urea-formaldehyde) and dried. If desired, a coating may be applied (coated granules) which enables the active ingredient to be released in metered amounts over a predetermined period of time.

Preferred formulations have especially the following compositions (%=percent by weight; ‘active ingredient mixture’ denotes the mixture of MCPA, bromoxynil and compound of formula I with the compound of formula II)

Emulsifiable Concentrates:

active ingredient mixture: from 1 to 90%, preferably from 5 to 20%

surface-active agent: from 1 to 30%, preferably from 10 to 20%

liquid carrier: from 5 to 94%, preferably from 70 to 85%

Dusts:

active ingredient mixture: from 0.1 to 10%, preferably from 0.1 to 5%

solid carrier from 99.9 to 90%, preferably from 99.9 to 99%

Suspension Concentrates:

active ingredient mixture: from 5 to 75%, preferably from 10 to 50%

water from 94 to 24%, preferably from 88 to 30%

surface-active agent: from 1 to 40%, preferably from 2 to 30%

Wettable Powders:

active ingredient mixture: from 0.5 to 90%, preferably from 1 to 80%

surface-active agent: from 0.5 to 20%, preferably from 1 to 15%

solid carrier: from 5 to 95%, preferably from 15 to 90%

Granules:

active ingredient mixture: from 0.1 to 30%, preferably from 0.1 to 15%

solid carrier: from 99.5 to 70%, preferably from 97 to 85%

The Examples that follow illustrate the invention further. They do not limit the invention.

### FORMULATION EXAMPLES

| F1. Emulsifiable concentrates | a) | b) | c) | d) |
|---|---|---|---|---|
| active ingredient mixture | 5% | 10% | 25% | 50% |
| calcium dodecylbenzenesulfonate | 6% | 8% | 6% | 8% |
| castor oil polyglycol ether | 4% | — | 4% | 4% |
| (36 mol of ethylene oxide) | | | | |
| octylphenol polyglycol ether | — | 4% | — | 2% |
| (7-8 mol of ethylene oxide) | | | | |
| cyclohexanone | — | — | 10% | 20% |
| aromatic C₉-C₁₂hydrocarbon mixture | 85% | 78% | 55% | 16% |

Emulsions of any desired concentration can be prepared from such concentrates by dilution with water.

| F2. Solutions | a) | b) | c) | d) |
|---|---|---|---|---|
| active ingredient mixture | 5% | 10% | 50% | 90% |
| 1-methoxy-3-(3-methoxy- | — | 20% | 20% | — |
| propoxy)-propane | | | | |
| polyethylene glycol (mol. wt. 400) | 20% | 10% | — | — |
| N-methyl-2-pyrrolidone | — | — | 30% | 10% |
| aromatic C₉-C₁₂hydrocarbon mixture | 75% | 60% | — | — |

The solutions are suitable for application in the form of micro-drops.

| F3. Wettable powders | a) | b) | c) | d) |
|---|---|---|---|---|
| active ingredient mixture | 5% | 25% | 50% | 80% |
| sodium lignosulfonate | 4% | — | 3% | — |
| sodium lauryl sulfate | 2% | 3% | — | 4% |
| sodium diisobutylnaphthalenesulfonate | — | 6% | 5% | 6% |
| octylphenol polyglycol ether | — | 1% | 2% | — |
| (7-8 mol of ethylene oxide) | | | | |
| highly dispersed silicic acid | 1% | 3% | 5% | 10% |
| kaolin | 88% | 62% | 35% | — |

The active ingredient is mixed thoroughly with the adjuvants and the mixture is thoroughly ground in a suitable mill, affording wettable powders which can be diluted with water to give suspensions of any desired concentration.

| F4. Coated granules | a) | b) | c) |
|---|---|---|---|
| active ingredient mixture | 0.1% | 5% | 15% |
| highly dispersed silicic acid | 0.9% | 2% | 2% |
| inorganic carrier material | 99.0% | 93% | 83% |
| (diameter 0.1-1 mm) | | | |
| for example CaCO₃ or SiO₂ | | | |

The active ingredient is dissolved in methylene chloride, the solution is sprayed onto the carrier, and the solvent is subsequently evaporated off in vacuo.

| F5. Coated granules | a) | b) | c) |
|---|---|---|---|
| active ingredient mixture | 0.1% | 5% | 15% |
| polyethylene glycol (mol. wt. 200) | 1.0% | 2% | 3% |
| highly dispersed silicic acid | 0.9% | 1% | 2% |
| inorganic carrier material | 98.0% | 92% | 80% |
| (diameter 0.1-1 mm) | | | |
| for example CaCO₃ or SiO₂ | | | |

The finely ground active ingredient is uniformly applied, in a mixer, to the carrier material moistened with polyethylene glycol, yielding non-dusty coated granules.

| F6. Extruder granules | a) | b) | c) | d) |
|---|---|---|---|---|
| active ingredient mixture | 0.1% | 3% | 5% | 15% |
| sodium lignosulfonate | 1.5% | 2% | 3% | 4% |
| carboxymethylcellulose | 1.4% | 2% | 2% | 2% |
| kaolin | 97.0% | 93% | 90% | 79% |

The active ingredient is mixed with the adjuvants, and the mixture is ground, moistened with water, extruded and then dried in a stream of air.

| F7. Dusts | a) | b) | c) |
|---|---|---|---|
| active ingredient mixture | 0.1% | 1% | 5% |
| talcum | 39.9% | 49% | 35% |
| kaolin | 60.0% | 50% | 60% |

Ready-to-use dusts are obtained by mixing the active ingredient with the carriers and grinding the mixture in a suitable mill.

| F8. Suspension concentrates | a) | b) | c) | d) |
|---|---|---|---|---|
| active ingredient mixture | 3% | 10% | 25% | 50% |
| ethylene glycol | 5% | 5% | 5% | 5% |
| nonylphenol polyglycol ether | — | 1% | 2% | — |
| (15 mol of ethylene oxide) | | | | |
| sodium lignosulfonate | 3% | 3% | 4% | 5% |
| carboxymethylcellulose | 1% | 1% | 1% | 1% |
| 37% aqueous formaldehyde solution | 0.2% | 0.2% | 0.2% | 0.2% |
| silicone oil emulsion | 0.8% | 0.8% | 0.8% | 0.8% |
| water | 87% | 79% | 62% | 38% |

The finely ground active ingredient is intimately mixed with the adjuvants, giving a suspension concentrate from which suspensions of any desired concentration can be obtained by dilution with water.

It is often more practical to formulate MCPA, bromoxynil, the compound of formula I and the mixing partner of formula II separately and then, shortly before application, to bring them together in the applicator in the desired mixing ratio in the form of a “tank mixture” in water. The ability of the safeners of formula II to protect cultivated plants against the phytotoxic action of mixtures of MCPA, bromoxynil and the compound of formula I is illustrated in the following Examples.

### BIOLOGICAL EXAMPLE

Examples B1: Post-emergence applications of mixtures of MCPA, bromoxynil and the herbicide of formula I wherein R₁ and R₃ are —C₂H₅; R₄ and R₅ together form a group —CR₁₄(R₁₅)—CR₁₆(R₁₇)—O—CR₁₈(R₁₉)—CR₂₀(R₂₁)— wherein R₁₄, R₁₅ R₁₆, R₁₇, R₁₈, R₁₉, R₂₀ and R₂₁ are hydrogen; and G is either hydrogen (=herbicide H1) or (CH₃)₃CC(O)— (=herbicide H2), with the safener of formula II wherein Rs₁ is chlorine and Rs₂ is 1-methylhexyl, in wheat and barley, and together with 3 different weeds.

The test plants are grown to a post-application stage in pots under greenhouse conditions. A standard soil is used as cultivation substrate. At a post-emergence stage, the herbicides, both on their own and in admixture with the safener, are applied to the test plants or to cultivated plants seed-dressed with safener. The application is carried out using an emulsion (prepared from a 25% emulsifiable concentrate (Example F1, b)) of the test substances using 500 litres of water per ha. The rates of application depend on the optimum concentrations ascertained under field conditions and greenhouse conditions. The tests are evaluated after 9, 10, 20 and 24 days (100% action=plant is completely dead, 0% action=no phytotoxic action). The results obtained show that the safener used can significantly reduce the damage caused to the cultivated plants by the herbicide mixture.

The same results are obtained when the active ingredient mixture is formulated in accordance with the other above-mentioned Formulation Examples.

1. A selectively herbicidal composition which, in addition to comprising customary inert formulation adjuvants such as carriers, solvents and wetting agents, comprises as active ingredient a mixture of
a) a herbicidally effective amount of a mixture of MCPA, bromoxynil and a herbicide of formula I 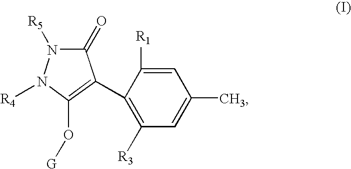
wherein R₁ and R₃ are each independently of the other ethyl, haloethyl, ethynyl, C₁- or C₂-alkoxy, C₁- or C₂-haloalkoxy, C₁- or C₂-alkylcarbonyl or C₁- or C₂-hydroxyalkyl;
R₄ and R₅ together are a group Z₂-CR₁₄(R₁₅)—CR₁₆(R₁₇)—O—CR₁₈(R₁₉)—CR₂₀(R₂₁)-(Z₂);
R₁₄, R₁₅, R₁₆, R₁₇, R₁₈, R₁₉, R₂₀ and R₂₁, are each independently of the others hydrogen, halogen, C₁-C₄alkyl or C₁-C₄haloalkyl, it being possible for an alkylene ring to be either fused or spiro-linked to the carbon atoms of the group Z₂, which alkylene ring contains, together with the carbon atoms of the group Z₂ to which it is bonded, from 2 to 6 carbon atoms and may be interrupted by oxygen, or that alkylene ring bridges at least one ring atom of the group Z₂;
G is hydrogen, —C(X₁)—R₃₀, —C(X₂)—X₃—R₃₁, —C(X₄)—NR₃₂(R₃₃), —S(O)₂—R₃₄, —P(X₅)R₃₅R₃₆, —CH₂—X₆—R₃₇ or an alkali metal cation, alkaline earth metal cation, sulfonium cation or ammonium cation;
X₁, X₂, X₃, X₄, X₅ and X₆ are each independently of the others oxygen or sulfur;
R₃₀, R₃₁, R₃₂, R₃₃, R₃₄, R₃₅, R₃₆ and R₃₇ are each independently of the others hydrogen, C₁-C₁₀alkyl, C₁-C₁₀haloalkyl, C₁-C₁₀cyanoalkyl, C₁-C₁₀nitroalkyl, C₁-C₁₀aminoalkyl, C₂-C₅-alkenyl, C₂-C₅haloalkenyl, C₃-C₈cycloalkyl, C₁-C₅alkylamino-C₁-C₅alkyl, di(C₁-C₅alkyl)amino-C₁-C₅alkyl, C₃-C₇cycloalkyl-C₁-C₅alkyl, C₁-C₅alkoxy-C₁-C₅alkyl, C₃-C₅alkenyloxy-C₁-C₅alkyl, C₃-C₅alkynyloxy-C₁-C₅alkyl, C₁-C₅alkylthio-C₁-C₆alkyl, C₁-C₅alkylsulfoxyl-C₁-C₅alkyl, C₁-C₅-alkylsulfonyl-C₁-C₅alkyl, C₂-C₈alkylideneaminooxy-C₁-C₅alkyl, C₁-C₅alkylcarbonyl-C₁-C₅alkyl, C₁-C₅alkoxycarbonyl-C₁-C₅alkyl, C₁-C₅alkylaminocarbonyl-C₁-C₅alkyl, di(C₁-C₆alkyl)amino-carbonyl-C₁-C₅alkyl, C₁-C₅alkylcarbonylamino-C₁-C₅alkyl, C₁-C₅alkylcarbonyl(C₁-C₅alkyl)-amino-C₁-C₅alkyl, tri(C₁- or C₂-alkyl)silyl-C₁-C₅alkyl, phenyl, heteroaryl, phenyl-C₁-C₅alkyl, heteroaryl-C₁-C₅alkyl, phenoxy-C₁-C₅alkyl or heteroaryloxy-C₁-C₅alkyl, it being possible for the afore-mentioned aromatic rings to be substituted by halogen, nitro, cyano, amino, di(C₁-C₄alkyl)amino, hydroxy, methoxy, ethoxy, methylthio, ethylthio, formyl, acetyl, propionyl, carboxyl, C₁-C₅alkoxycarbonyl or by C₁- or C₂-haloalkyl;
R₃₄, R₃₅ and R₃₆ are, in addition, C₁-C₁₀alkoxy, C₁-C₁₀haloalkoxy, C₁-C₅alkylamino, di(C₁-C₅alkyl)amino, benzyloxy or phenoxy, it being possible for the aromatic rings of the last two substituents to be substituted by halogen, nitro, cyano, amino, dimethylamino, hydroxy, methoxy, ethoxy, methylthio, ethylthio, formyl, acetyl, propionyl, carboxyl, C₁-C₅alkoxy-carbonyl or by C₁- or C₂-haloalkyl; and
R₃₇ is, in addition, C₁-C₁₀alkylcarbonyl,
or a salt or diastereoisomer of a compound of formula I, and
b) an amount, effective for herbicide antagonism, of a safener of formula II 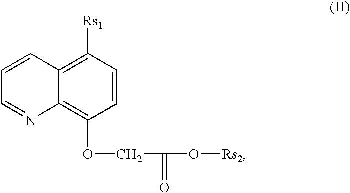
wherein Rs₁ is hydrogen or chlorine and Rs₂ is hydrogen, C₁-C₈alkyl, or C₁-C₈alkyl substituted by C₁-C₆alkoxy or by C₃-C₆alkenyloxy.

2. A composition according to claim 1, which comprises, as compound of formula II, a compound of that formula wherein Rs₁ is chlorine and Rs₂ is C₁-C₈alkyl.

3. A composition according to claim 1, which comprises, as compound of formula I, a compound of that formula wherein R₁ and R₃ are each independently of the other ethyl, haloethyl, ethynyl, C₁- or C₂-alkoxy or C₁- or C₂-haloalkoxy.

4. A composition according to claim 1, which comprises, as compound of formula I, a compound of that formula wherein R₄ and R₅ together form a group Z₂-CR₁₄(R₁₅)—CR₁₆(R₁₇)—O—CR₁₈(R₁₉)—CR₂₀(R₂₁)-(Z₂)
wherein R₁₄, R₁₅, R₁₆, R₁₇, R₁₈, R₁₉, R₂₀ and R₂₁, are hydrogen.

5. A composition according to claim 1, which comprises, as compound of formula I, a compound of that formula wherein G is hydrogen, —C(X₁)—R₃₀, —C(X₂)—X₃-R₃₁, —C(X₄)—NR₃₂(R₃₃), —S(O)₂—R₃₄, —P(X₅)R₃₅R₃₆, —CH₂—X₆—R₃₇ or an alkali metal cation, alkaline earth metal cation, sulfonium cation or ammonium cation; X₁, X₂, X₃, X₄, X₅ and X₆ are each independently of the others oxygen or sulfur; R₃₀, R₃₁, R₃₂, R₃₃, R₃₄, R₃₅, R₃₆ and R₃₇ are each independently of the others hydrogen, C₁-C₈alkyl, C₁-C₈haloalkyl, C₁-C₈cyanoalkyl, C₁-C₈nitroalkyl, C₁-C₈amino-alkyl, C₂-C₅alkenyl, C₂-C₅haloalkenyl, C₃-C₈cycloalkyl, C₁-C₅alkylamino-C₁-C₂alkyl, di(C₁-C₅alkyl)amino-C₁-C₂alkyl, C₃-C₇cycloalkyl-C₁-C₂alkyl, C₁-C₄alkoxy-C₁-C₄alkyl, C₂-C₄alkenyloxy-C₁-C₄alkyl, C₃-C₄alkynyloxy-C₁-C₄alkyl, C₁-C₄alkylthio-C₁-C₄alkyl, C₁-C₂alkylsulfoxyl-C₁-C₂alkyl, C₁-C₂alkylsulfonyl-C₁-C₂alkyl, C₂-C₈alkylideneaminooxy-C₁-C₂alkyl, C₁-C₅alkylcarbonyl-C₁-C₂alkyl, C₁-C₅alkoxycarbonyl-C₁-C₂alkyl, C₁-C₅alkylamino-carbonyl-C₁-C₂alkyl, di(C₁-C₄alkyl)aminocarbonyl-C₁-C₂alkyl, C₁-C₅alkylcarbonylamino-C₁-C₂alkyl, C₁-C₂alkylcarbonyl(C₁-C₃alkyl)amino-C₁-C₂alkyl, tri(C₁- or C₂-alkyl)silyl-C₁-C₃alkyl, phenyl, heteroaryl, phenyl-C₁-C₂alkyl, heteroaryl-C₁-C₂alkyl, phenoxy-C₁-C₂alkyl or heteroaryloxy-C₁-C₂alkyl; R₃₄, R₃₅ and R₃₆ are, in addition, C₁-C₆alkoxy, C₁-C₆haloalkoxy, C₁-C₃alkylamino, di(C₁-C₃alkyl)amino, benzyloxy or phenoxy, it being possible for the aromatic rings of the last two substituents to be substituted by halogen, nitro, cyano, amino, dimethylamino, hydroxy, methoxy, ethoxy, methylthio, ethylthio, formyl, acetyl, propionyl, carboxyl, C₁-C₆alkoxycarbonyl or by C₁- or C₂-haloalkyl; and R₃₇ is, in addition, C₁-C₈alkyl-carbonyl.

6. A composition according to claim 5, which comprises, as compound of formula I, a compound of that formula wherein G is hydrogen, —C(X₁)—R₃₀, —C(X₂)—X₃—R₃i, —C(X₄)—NR₃₂(R₃₃), —S(O)₂-R₃₄, —P(X₅)R₃₅R₃₆, —CH₂—X6—R₃₇ or an alkali metal cation, alkaline earth metal cation, sulfonium cation or ammonium cation; X₁, X₂, X₃, X₄, X₅ and X₆ are each independently of the others oxygen or sulfur; R_{30, R}₃₁, R₃₂, R₃₃, R₃₄, R₃₅, R₃₆ and R₃₇, are each independently of the others hydrogen, C₁-C₈alkyl, C₁-C₈haloalkyl, C₂-C₅alkenyl, C₂-C₅haloalkenyl, C₃-C₈cycloalkyl, C₃-C₇cycloalkyl-C₁-C₂alkyl, C₁-C₄alkoxy-C₁-C₄alkyl, phenyl, heteroaryl, phenyl-C₁-C₂alkyl, heteroaryl-C₁-C₂alkyl, phenoxy-C₁-C₂alkyl or heteroaryloxy-C₁-C₂alkyl; R₃₄, R₃₅ and R₃₆ are, in addition, C₁-C₆alkoxy, C₁-C₃alkylamino, di(C₁-C₃alkyl)amino; and R₃₇ is, in addition, C₁-C₈-alkylcarbonyl.

7. A composition according to claim 1, which comprises a) a mixture of MCPA, bromoxynil and a herbicide of formula I wherein G is hydrogen or —C(X₂)—X₃—R₃₁, wherein X₂ and X₃ are oxygen, and R₃₁ is tert-butyl, and b) a safener of formula II wherein Rs₁ is chlorine and Rs₂ is 1 -methylhexyl.

8. A composition according to claim 1, which comprises an additive comprising an oil of vegetable origin, or an alkylated derivative thereof, or a mineral oil, or a mixture thereof.

9. A composition according to claim 8, which comprises an additive comprising an oil of vegetable origin having the components (A) from 20 to 90% by weight of alkyl esters of higher (C₄-C₂₂) fatty acids, (B) from 4 to 40% by weight of anionic or non-ionic surfactants, (C) from 2 to 20% by weight of higher (C₁₀-C₂₀) fatty acids, and (D) up to 140% by weight, based on the total amount of components (A) to (C), of hydrocarbons.

10. A composition according to claim 8, which comprises an additive comprising an oil of vegetable origin having the components (A) C₁-C₄alkyl esters of C,₂-C,₈ fatty acids, (B) anionic surfactants of the dodecylbenzylsulfonate type, (C) C₁₂-C₁₈ fatty acids, and (D) aromatic hydrocarbons.

11. A method of selectively controlling weeds and grasses in crops of useful plants, which method comprises treating the useful plants, their seeds or cuttings or the crop area thereof, simultaneously or separately, with a) a herbicidally effective amount of a mixture of MCPA, bromoxynil and a herbicide of formula I, b) an amount, effective for herbicide antagonism, of a safener of formula II and, optionally, c) an additive comprising an oil of vegetable origin, or an alkylated derivative thereof, or a mineral oil, or a mixture thereof.

12. A method according to claim 11, which comprises treating crops of useful plants or areas for crops of useful plants with from 0.005 to 0.5 kg/ha of the herbicidal mixture and an amount of from 0.001 to 0.5 kg/ha of a safener of formula II.

13. A method according to claim 11, wherein the crop of useful plants is a cereal, maize or sorghum.
